(19) United States
(12) Patent Application Publication
(10) Pub. No.: US 2023/0005013 A1
(43) Pub. Date: Jan. 5, 2023

(54) MEASUREMENT OF EFFECTS OF CONTENT EXPOSURE USING DISTRIBUTED COMPUTATION

(71) Applicant: INMARKET MEDIA, LLC, Culver City, CA (US)

(72) Inventors: Mark Christopher DIXON, Belmont, CA (US); Clark Alan BURDICK, Sunnyvale, CA (US)

(21) Appl. No.: 17/854,156

(22) Filed: Jun. 30, 2022

Related U.S. Application Data
(60) Provisional application No. 63/216,636, filed on Jun. 30, 2021.

(51) Int. Cl. G06Q 30/02

(52) U.S. Cl. CPC G06Q 30/0243; G06Q 30/0246

(57) ABSTRACT

Some implementations disclosed herein measure an effect of content exposure (e.g., lift attributable to ad campaign content) by comparing exposed and unexposed conversion (e.g., visit) rates. The measurement processing is distributed between the computing systems used/controlled by different entities: a processing entity and a conversion data collection entity (e.g., a selling entity) so that identifier-level conversion data (e.g., user-level conversion data, device-level conversion data, household-level conversion data, etc.) does not need to leave the conversion data collection entity system(s).

### CROSS-REFERENCE TO RELATED APPLICATIONS

This application claims the benefit of U.S. Provisional Application Ser. No. 63/216,636 filed Jun. 30, 2021, which is incorporated herein in its entirety.

### FIELD OF THE INVENTION

This disclosure relates generally to devices and systems that utilize user data from multiple sources to assess the effectiveness of marketing campaigns and other advertising content while maintaining data privacy.

### BACKGROUND

Various techniques are used to measure the effectiveness of marketing campaign and other advertising content. For example, a processing entity may receive (a) impression data related to ads provided by one or more advertisers regarding products or services provided by a selling entity and (b) conversion data related to conversions by the selling entity and use such data to measure the effectiveness of the ads provided by the advertisers. Such systems generally require that the selling entity provide detailed (and potentially sensitive, private, and/or otherwise customer-specific) information in providing the conversion data to the processing entity. It may be desirable to enable the determination of marketing campaign/advertising content effectiveness measurements via a processing entity without requiring that selling (or other conversion data collection) entities release such potentially sensitive, private, and/or otherwise customer specific information to the processing entity.

### SUMMARY

Some implementations disclosed herein measure an effect of content exposure (e.g., lift attributable to ad campaign content) by comparing exposed and unexposed conversion (e.g., visit) rates. The measurement processing is distributed between computing systems that are used and/or controlled by different entities: a processing entity and a conversion data collection entity (e.g., a selling entity) so that identifier-level conversion data (e.g., user-level conversion data, device-level conversion data, household-level conversion data, etc.) does not need to leave the conversion data collection entity system(s).

In one exemplary implementation, a processor within a first computing environment executes instructions stored in a computer-readable medium to perform a method. The method determines exposed group data and unexposed group data, the exposed group data identifying user identities of users exposed to content and the unexposed group data identifying user identities of users not exposed to the content. The method further transmits the exposed group data and unexposed group data to a second computing environment, wherein the second computing environment is configured to compute aggregate data based on the exposed group data, the unexposed group data, and identifier-level conversion data, wherein the second computing environment is distinct from the first computing environment. The method receives the aggregated data from the second computing environment and determines an effect of exposure to the content (e.g., incremental lift attributable to ad campaign content) by comparing exposed and unexposed conversion (e.g., visit) rates determined based on the received aggregate data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE FIGURES

These and other features, implementations, and advantages of the present disclosure are better understood when the following Detailed Description is read with reference to the accompanying drawings.

FIG. 1 illustrates an exemplary computing environment according to some implementations disclosed herein.

FIG. 2 illustrates an exemplary distributed computing environment according to some implementations disclosed herein.

FIG. 3 is a flow chart illustrating an exemplary method for measuring the effects of content exposure using distributed computation according to some implementations disclosed herein.

FIG. 4 illustrates an example of measuring the effects of content exposure using distributed computation according to some implementations disclosed herein.

FIG. 5 is a block diagram depicting an example hardware implementation.

### DETAILED DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

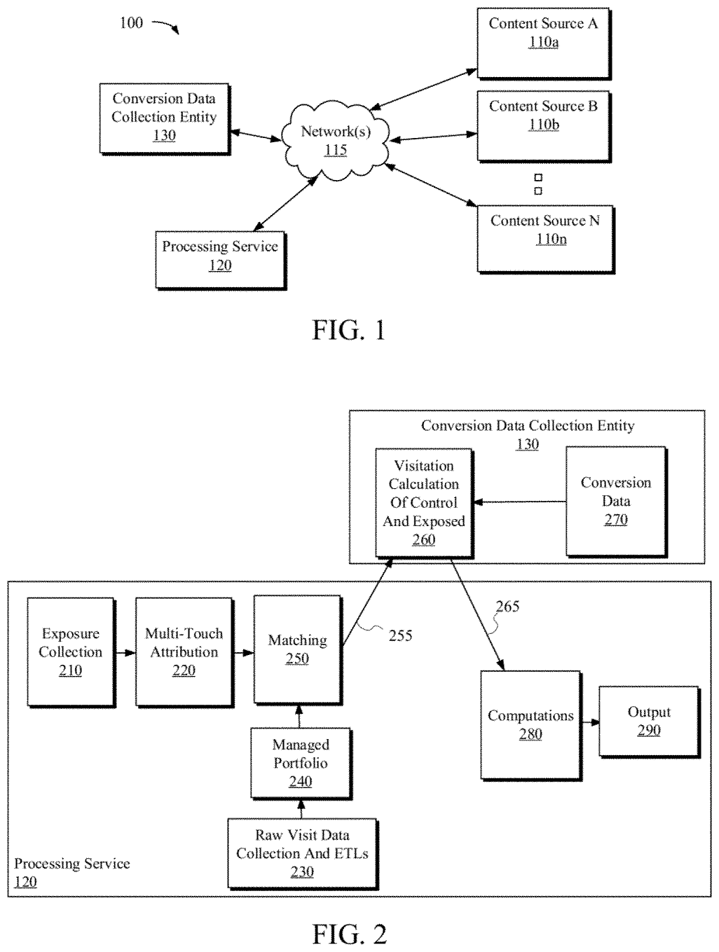

FIG. 1 illustrates an exemplary computing environment 100 in which computation of the effects of content exposure may be measured. In this example, content (e.g., ads and/or other advertising campaign content) are provided by content sources A-N 110a-n to potential actors, e.g., customers or users who may convert, for example, by making a purchase from a seller. A conversion data collection entity 130, which may be a seller or an affiliate of a seller as examples, collects information about conversions, e.g., customer A visited store B or purchased product C for price D on date E, etc. Processing service 120 facilitates measurement of the effects of content exposure, e.g., how effective the advertising campaign content provided by each of source A-N 110a were with respect to resulting in purchases or other conversions by the recipients of the advertising campaign content.

Measuring the effects of content exposure may involve a location conversion index to measure advertising driven conversion, e.g., data to attribute incremental store visits to marketing campaigns. This may involve a comparison of exposed and unexposed conversion (e.g., visit) rates, where conversion rates are calculated: conversion rate=conversions/users. Incremental lift may be calculated as the percentage increase between the exposed conversion/visit rate (EVR) and the unexposed conversion/visit rate (UVR). Incremental Lift=(EVR−UVR)/UVR.

In some implementations, some of the computations involved in measuring the effects of the content exposure are performed externally from the processing service 120 (e.g., by the conversion data collection entity 130 such as a seller) such that processing server 120 need not receive potentially sensitive, private, and/or otherwise identifier-level-specific information. Rather, such potentially sensitive, private, and/or otherwise identifier-level-specific information may be used locally (e.g., without distribution to other parties) by the entity that collects that information, e.g., conversion data collection entity 130.

FIG. 2 illustrates an exemplary distributed computing environment in which processing server 120 facilitates the measurement of the effects of content exposure without receiving potentially sensitive, private, and/or otherwise identifier-level-specific information from the conversion data collection entity 130. In FIG. 2, exposure collection 210 is performed, for example, by collecting information about which users were provided content by content sources A-N 110a-n, when such content was provided, etc. Multi-touch attribution 220 is performed, for example, to determine a level, amount, percentage or other information about the relative amount of content provided by each of the content source A-N 110a-n to the individual users, who may or may not have ended up converting.

At block 230, raw conversion/visit data is obtained and, if necessary, extract, transform, and load (ETL) 230 analysis is performed to cleanse and consolidate different data sets. The conversion/visit data may be converted by managed portfolio block 240, for example, using a conversion table and matching performed at block 250 to identify an exposed group of users. Data 255 representing the exposed group of users and a control group is sent from the first processing environment, i.e., processing service 120, to the second processing environment, i.e., the conversion data collection entity 130. The conversion data collection entity 130 uses the received data 255 representing the exposed group of users and the control group and its own collected conversion data 270 to generate aggregate counts of conversions and users. Data 265 representing the aggregate counts of conversions and users is sent back to the first processing environment, i.e., the processing service, which performs computations 280 using the received data to provide output 290 corresponding to the effects of the content exposure. For example, this may involve determining incremental lift as the percentage increase between the exposed conversion/visit rate (EVR) and the unexposed conversion/visit rate (UVR), where incremental Lift=(EVR−UVR)/UVR. In this example, identifier-level specific data is retained in the second environment, i.e., at the conversion data collection entity 130, and only aggregate data is provided to the first environment, i.e., to the processing service 120.

In some implementations, to enable multi-touch attribution (MTA) 220, MTA weights are generated by processing service 120 and provided to the conversion data collection entity 130, which uses the MTA weights to compute and provide back more generalized information.

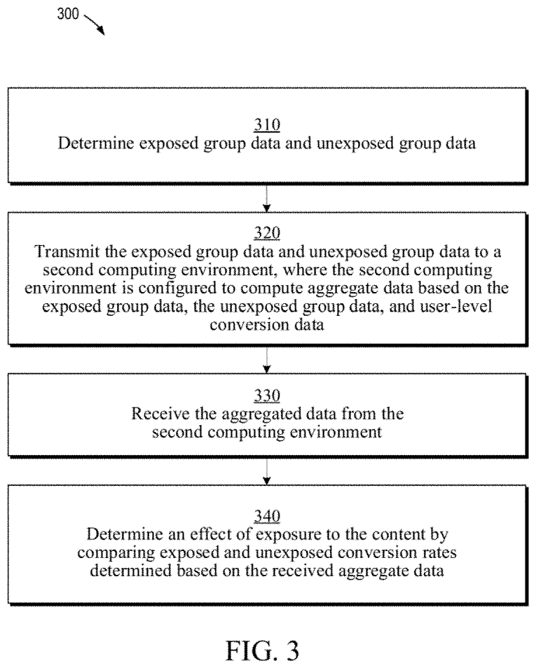

FIG. 3 is a flow chart illustrating an exemplary method 300 for measuring the effects of content exposure using distributed computation. The exemplary method 300 can be implemented via a computing device, for example, by using a processor to execute instructions stored in a non-transitory computer-readable medium. Reference to the method 300 being performed by a computing device includes the method 300 being performed by one or more computing devices and/or using one or more processors.

At block 310, the method 300 determines exposed group data and unexposed group data. The exposed group data identifies user identities of users exposed to content and the unexposed group data identifies user identities of users not exposed to the content. In some implementations, a processing service obtains exposure data, computes multi-touch attribution (MTA), and optionally performs matching to identify users for the unexposed group. The matching may identify users for the unexposed group having one or more attributes matching attributes of the exposed group users. The exposed group data and unexposed group data may correspond to exposure/non-exposure during a defined time window.

The unexposed group may be identified based on data received from the second computing environment, where the second computing environment generates the data by generalizing the identifier-level conversion data for individual users. For example, the processing service may identify the unexposed group based on data received from the second computing environment, e.g., based on receiving identifier-level-specific data that is generalized/abstracted, for example, regarding precampaign conversion rate, to unexposed users who visit retailer X as frequently as the exposed visitors. This may involve dividing a user set into abstract classifications to select an unexposed group that matches the unexposed group data without needing identifier-level-specific conversion data, e.g., based on the user being within the 40^{th} to 50th percentile with respect to number of retailer X visits without knowing the actual number of visits.

At block 320, the method 300 transmits the exposed group data and unexposed group data to a second computing environment, where the second computing environment is configured to compute aggregate data based on the exposed group data, the unexposed group data, and identifier-level conversion data. In some implementations, the aggregate data includes aggregate counts of exposed conversions, exposed users, unexposed conversions, unexposed users, standard deviation of conversion for the exposed users, and/or standard deviation of conversion for the unexposed users. The aggregate data may include aggregate counts of, sub-dimension data, including exposed conversions, exposed users, unexposed conversions, and unexposed users. The aggregate data may include matched rate data.

The second computing environment is distinct from the first computing environment, e.g., provided via different computing devices and/or operated by or under the control of different entities. In some implementations, the first computing environment comprises information that is confidentially maintained for a first business entity and the second computing environment comprises information that is confidentially maintained for a second business entity different than the first business entity.

In some implementations, a processing service sends data regarding exposed groups and non-exposed (i.e., control) groups to a module (e.g., a conversion abstraction module (CAM)) that is within the conversion data collection entity (retailer X's) systems. This module may use the received data and the second party's conversion data to compute aggregate values (e.g., aggregate counts of conversions and users: (1) exposed conversions/visits, (2) exposed users, (3) unexposed conversions/visits, and (4) unexposed users. MTA weights may also be sent, which may enable the module to convert MTA weighted conversions without the processing service seeing the conversions. In some implementations, such a module is implemented using an API exposed to the processing party. Exposed group data and unexposed group data may be sent to such a module within the second computing environment via an application programming interface (API) call.

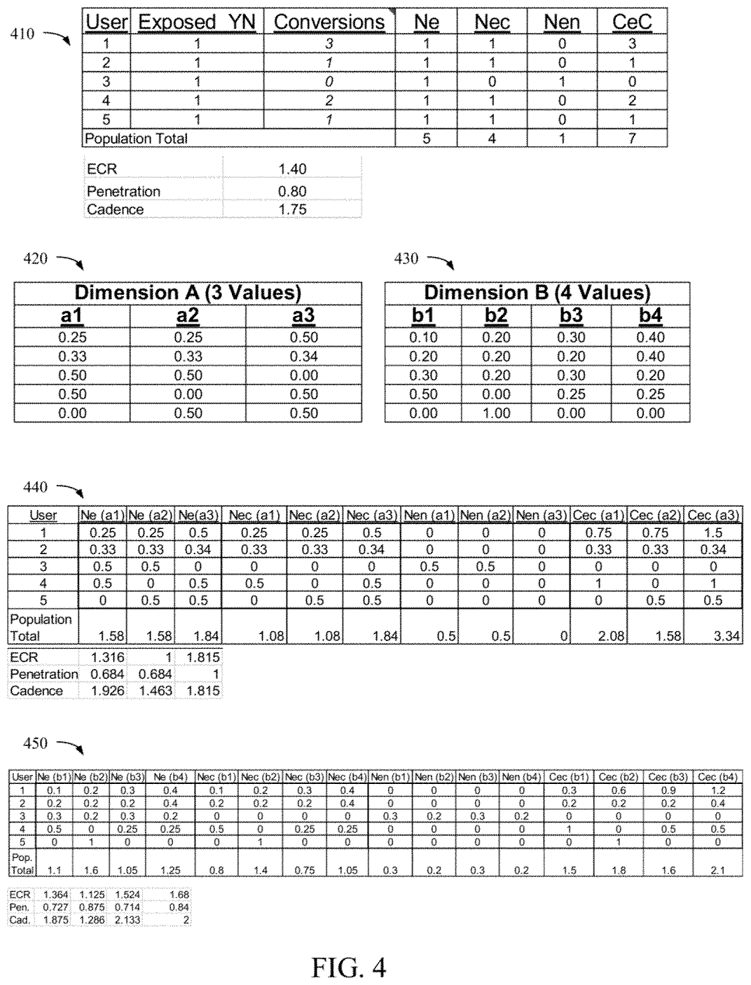

In some implementations, the multi-touch attribution (MTA) weights are computed in the first computing environment and provided to MTA to the second computing environment and the second computing environment performs MTA weighted conversions using the MTA weights such that the first computing environment is prohibited from accessing the MTA weighted conversions, although aggregate values may be provided to the first computing environment as illustrated in FIG. 4.

At block 330, the method 300 receives the aggregated data from the second computing environment and, at block 340, the method determines an effect of exposure to the content (e.g., incremental lift attributable to ad campaign content) by comparing exposed and unexposed conversion (e.g., visit) rates determined based on the received aggregate data. Incremental lift may be calculated as percentage increase between an exposed conversion/visit rate (EVR) and an unexposed conversion/visit rate (UVR). this percentage increase may be calculated using four aggregate numbers (exposed conversions/visits, exposed users, unexposed conversions/visits, and unexposed users).

Method 300 may be performed such that the first computing environment does not receive the identifier-level conversion data. Raw identifier-level conversion data need not leave the second party environment. Thus, identifier-level conversion data may be exclusively maintained within the second computing environment.

In some implementations, the data that is shared with the first computing environment comprises limited identifier-level data but does not reveal conversion-specific data. For example, such data may identify that a customer is within the 40th percentile without revealing that that the customer spent $50.

FIG. 4 illustrates an example of measuring the effects of content exposure using distributed computation. Chart 410 illustrates identifier-level-specific information that may be tracked by a conversion data collection entity 130 (e.g., a retailer, a credit card transaction tracker, or any other entity that collects data about sales or other types of conversions) about customer conversions. In this example, this information includes, for each user, a number of exposed device (Exposed YN), a number of conversions (Conversions), a number exposed (Ne), a number exposed that converted (Nec), a number exposed that did not convert (Nen), and a number of conversions by the exposed that converted (CeC). Identifier-level-specific information such as this may be maintained by the conversion data collection entity 130.

In contrast, aggregate information such as the population totals for Ne, Nec, Nen, and Cec values may be shared by the conversion data collection entity 130 with the processing service 120. The processing service 120 may use the received aggregate data to determine, for example, an exposed conversion rate (ECR) based on the aggregate number of conversions by exposed users (CeC) divided by the aggregate number exposed users (Ne), a penetration based the aggregate number exposed that converted (Nec) divided by the aggregate number of exposed users (Ne), and a cadence based on the aggregate number of conversions by exposed users (CeC) divided by the aggregate number exposed that converted (Nec).

In this example, the processing service 120 collects impression data for users (e.g., users 1-5) and uses that impression data to determine MTA weights, which are illustrated in tables 420 and 430. These MTA weights may be generated for different population segmentations as illustrated in FIG. 4. For example, users may be segmented into different groups, e.g., publishers and creatives, and weights determined for the attributions of different content providers based on the impressions provided by those content providers. For example, for user 1 in dimension A, content provider 1 has attribution 0.25, content provider 2 has attribution 0.25, and content provider 3 has attribution 0.5. The identifier-level-specific and dimension-specific MTA weights illustrated in tables 420 and 430 are generated by processing service 120 and provided to the conversion data collection entity 130, e.g., via an API call or otherwise.

The conversion data collection entity 130 (e.g., a conversion abstraction module (CAM) implemented by the conversion data collection entity 130) receives the MTA weights and uses it to perform calculations based on its identifier-level-specific conversion information. In this example, the conversion data collection entity 130 uses the received MTA weights and its identifier-level-specific conversion data to generate tables 440 and 450. Table 440 is specific to the first dimension (e.g., based on the MTA weights of table 420) and identifies, for each user, the attribution of Ne, Nec, Nen, and Cec to each content source (e.g., a1, a2, a3). Table 450 is specific to the second dimension (e.g., based on the MTA weights of table 430) and identifies, for each user, the attribution of Ne, Nec, Nen, and Cec to each content source (e.g., b1, b2, b3, b4). Identifier-level-specific information such as this may be maintained by the conversion data collection entity 130.

In contrast, aggregate information such as the population totals in charts 440 and 450 for Ne, Nec, Nen, and Cec values may be shared by the conversion data collection entity 130 with the processing service 120. In this example, 1.58 is the number of exposed users attributed to a1, 1.58 is the number exposed users attributed to a2, 1.84 is the number or exposed users attributed to a3, and these values sum to 5 which is the overall aggregate value of Ne shown in chart 410. The processing service 120 may use the received aggregate data to determine, for example, for each content source, attribution of an exposed conversion rate (ECR) based on the aggregate number of conversions by exposed users (CeC) divided by the aggregate number exposed users (Ne), a penetration based the aggregate number exposed that converted (Nec) divided by the aggregate number of exposed users (Ne), and a cadence based on the aggregate number of conversions by exposed users (CeC) divided by the aggregate number exposed that converted (Nec).

In some implementations, a distributed computation model, e.g., using a CAM at conversion data collection entity 130 separate from a processing service 120, is configured to facilitate campaign analytics, e.g., generating and providing insights associated with a campaign. Existing processing services are unable to perform detailed analytics reporting on the converting users in circumstances in which identifier-level-specific conversion data is not shared. In some implementations, processing service 120 sends conversion data collection entity 130 a list of attributes (e.g., age range, gender, occupation, etc.) for a user, household, or any other unit for which analytics is desired (e.g., a geographic grouping). The conversion data collection entity 130 (e.g., the CAM) appends its own identifier-level-specific data with the received attributes, at the identifier level (e.g., user level, device level, household level, etc.). The service provider 120 sends a communication to the conversion data collection entity 130 (e.g., the CAM) asking or instruction the conversion data collection entity 130 to query the data for an insight, e.g., what is the average basket size for purchases made by males versus female who were exposed to the campaign? The conversion data collection entity 130 (e.g., CAM) returns the aggregate results (e.g. one number for the males and one number for the females).

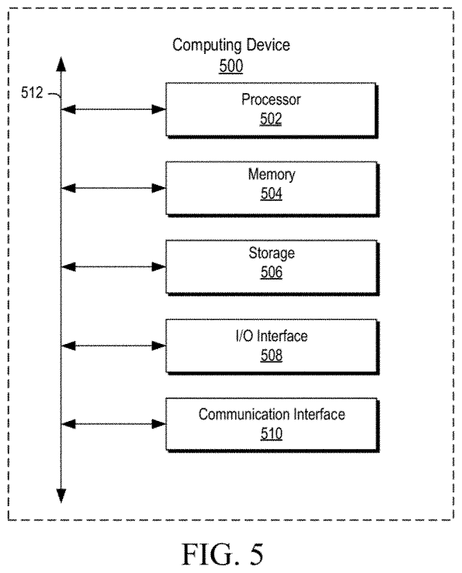

FIG. 5 is a block diagram depicting an example hardware implementation for the devices described in FIG. 1. Each such device 500 may include a processor 502 that is communicatively coupled to memory 504 and storage 506 and that executes computer-executable program code and/or access information stored in the memory 504 and storage 506. The processor 502 may comprise a microprocessor, an application-specific integrated circuit (“ASIC”), a state machine, or other processing device. The processor 502 can include any of a number of processing devices, including one. Such a processor 502 can include or may be in communication with a computer-readable medium storing instructions that, when executed by the processor, cause the processor to perform the operations described herein.

The memory 504 and storage 506 can include any suitable computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, and ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++ C#, Visual Basic, Java, Python, Perl, and JavaScript.

The device 500 may also comprise a number of external or internal devices such as input or output devices. For example, the device 500 may have input/output (“I/O”) interface 508 that can receive input from input devices or provide output to output devices. A bus 512 can also be included in the device 500. The bus 512 can communicatively couple one or more components.

The device 500 can also include at least one network interface device or other communication interface 510. The communication interface 500 can include any device or group of devices suitable for establishing a wired or wireless data or telephone connection to one or more networks. Non-limiting examples of a network interface device include an Ethernet network adapter, a modem, and/or the like. A device can transmit messages as electronic or optical signals.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not be described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more Implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The foregoing description and summary of the invention are to be understood as being in every respect illustrative and exemplary, but not restrictive, and the scope of the invention disclosed herein is not to be determined only from the detailed description of illustrative Implementations but according to the full breadth permitted by patent laws. It is to be understood that the Implementations shown and described herein are only illustrative of the principles of the present invention and that various modification may be implemented by those skilled in the art without departing from the scope and spirit of the invention.

What is claimed is:

1. A method comprising:
at a processor within a first computing environment:
determining exposed group data and unexposed group data, the exposed group data identifying user identities of users exposed to content and the unexposed group data identifying user identities of users not exposed to the content;
transmitting the exposed group data and unexposed group data to a second computing environment, wherein the second computing environment is configured to compute aggregate data based on the exposed group data, the unexposed group data, and identifier-level conversion data, wherein the second computing environment is distinct from the first computing environment;
receiving the aggregated data from the second computing environment; and
determining an effect of exposure to the content by comparing exposed and unexposed conversion rates determined based on the received aggregate data.

2. The method of claim 1, wherein the first computing environment does not receive the identifier-level conversion data.

3. The method of claim 1, wherein the identifier-level conversion data is exclusively maintained within the second computing environment.

4. The method of claim 1, wherein the unexposed group is identified by identifying users having one or more attributes matching one or more attributes of users of the exposed group.

5. The method of claim 4, wherein the unexposed group is identified based on data received from the second computing environment, wherein the second computing environment generates the data by generalizing the identifier-level conversion data for individual users.

6. The method of claim 1, wherein the exposed group data and unexposed group data correspond to a specified time period.

7. The method of claim 1 further comprising computing multi-touch attribution (MTA) weights and providing the MTA weights to the second computing environment, wherein the second computing environment performs MTA weighted conversions using the MTA weights and the first computing environment is prohibited from accessing the MTA weighted conversions.

8. The method of claim 1, wherein the exposed group data and unexposed group data are sent to a module within the second computing environment via an application programming interface (API) call, wherein results are returned via an API response.

9. The method of claim 1, wherein the aggregate data comprises aggregate counts of exposed conversions, exposed users, unexposed conversions, unexposed users, standard deviation of conversion for the exposed users, and standard deviation of conversion for the unexposed users.

10. The method of claim 1, wherein the aggregate data comprises aggregate counts of, sub-dimension data, comprising exposed conversions, exposed users, unexposed conversions, and unexposed users.

11. The method of claim 1, wherein the aggregate data comprises matched rate data.

12. The method of claim 1, wherein determining the effect of exposure to the content comprises determining incremental lift attributable to ad campaign content by comparing the exposed and the unexposed conversion rates determined based on the received aggregate data.

13. The method of claim 12, wherein the incremental lift is calculated as a percentage increase between an exposed conversion rate and an unexposed conversion rate based on exposed conversions, exposed users, unexposed conversions, and unexposed users.

14. The method of claim 1, wherein the aggregate data comprises data identifying some identifier-level data without revealing conversion-specific data.

15. The method of claim 1, wherein:
the first computing environment comprises information that is confidentially maintained for a first business entity; and
the second computing environment comprises information that is confidentially maintained for a second business entity different than the first business entity.

16. The method of claim 1, further comprising:
sending a list of one or more attributes to the second computing environment, wherein the second computing environment appends its own identifier-level-specific data with the attributes, at the identifier level; and
sending a communication to the second computing environment regarding an insight associated with the one or more attributes; and
receiving a response to the communication comprising the insight, wherein the response does not provide identifier-level-specific data.

17. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
determining exposed group data and unexposed group data, the exposed group data identifying user identities of users exposed to content and the unexposed group data identifying user identities of users not exposed to the content;
transmitting the exposed group data and unexposed group data to a second computing environment, wherein the second computing environment is configured to compute aggregate data based on the exposed group data, the unexposed group data, and identifier-level conversion data, wherein the second computing environment is distinct from the first computing environment;
receiving the aggregated data from the second computing environment; and
determining an effect of exposure to the content by comparing exposed and unexposed conversion rates determined based on the received aggregate data.

18. The electronic device of claim 17, wherein the first computing environment does not receive the identifier-level conversion data.

19. The electronic device of claim 17, wherein the identifier-level conversion data is exclusively maintained within the second computing environment.

20. The electronic device of claim 17, wherein the unexposed group is identified by identifying users having one or more attributes matching one or more attributes of users of the exposed group.

21. The electronic device of claim 20, wherein the unexposed group is identified based on data received from the second computing environment, wherein the second computing environment generates the data by generalizing the identifier-level conversion data for individual users.

22. A non-transitory computer-readable storage medium, storing program instructions computer-executable on a computer to perform operations comprising:
determining exposed group data and unexposed group data, the exposed group data identifying user identities of users exposed to content and the unexposed group data identifying user identities of users not exposed to the content;
transmitting the exposed group data and unexposed group data to a second computing environment, wherein the second computing environment is configured to compute aggregate data based on the exposed group data, the unexposed group data, and identifier-level conversion data, wherein the second computing environment is distinct from the first computing environment;
receiving the aggregated data from the second computing environment; and
determining an effect of exposure to the content by comparing exposed and unexposed conversion rates determined based on the received aggregate data.
